(19) United States
(12) Patent Application Publication
(10) Pub. No.: US 2008/0115946 A1
(43) Pub. Date: May 22, 2008

(54) Horseshoe For Accomodating Locking Cleats

(76) Inventor: Sergio Baruffolo, Bochum (DE)

Correspondence Address: JAMES C. WRAY, 1493 CHAIN BRIDGE ROAD, SUITE 300, MCLEAN, VA, 22101, US

(21) Appl. No.: 11/883,859

(22) PCT Filed: Nov. 11, 2005
(86) PCT No.: PCT/DE05/02028

§ 371 Date: Aug. 7, 2007

(30) Foreign Application Priority Data
Feb. 24, 2005 (DE) 20 2005 003 010.4

(51) Int. Cl. A01L 7/04

(52) U.S. Cl. 168/42; 168/29

(57) ABSTRACT

A horseshoe 1 for equestrian sport has several holes 2, 3, 4, 5 for accommodating locking cleats 6. The holes 2 are provided on the underside 7 of the horseshoe 1 with a locking projection 8 of smaller diameter with a depth of 3-5 mm corresponding to the cleats 6. In addition or alternatively thereto an adapter 10 is inserted into at least one of the holes 2 serving to accommodate a cleat 6. This is made of hardened material and corresponds with the entire hole 2 or only with the locking projection 8.

The invention relates to a horseshoe for equestrian sport with several holes for accommodating locking cleats.

Horses have to be shod with horseshoes at regular intervals. Horseshoes for horses that mainly run on soft ground are also provided with cleats on the underside of the horseshoe in order to give the horses the necessary secure step on substrates that do not provide adequate stability. Usually cleats are used which are connected to the horseshoe by means of screw-type connections. However, in recent times cleats have become more and more established that are secured to the horseshoes by means of locking connections. Such cleats are known, for example, from DE-OS 102 61 085 and to have great benefits in many respects. A locking connection is much easier to produce than a screw-type connection. The locking cleats can be attached and detached more easily, and it is practically impossible for them to become loose while riding, and soiling of the holes is no longer a problem as the cleats can also be attached in these conditions. In order to achieve a particularly secure connection between the horseshoe and the cleat and therefore achieve long durability of the cleats it is however necessary to standardly produce not only the cleats, but also the accommodating horseshoes as accurately as possible so that they can withstand the highest requirements and loadings and that errors in production and preparation of horseshoes are practically ruled out.

On the basis of this the object of the present invention is to create a horseshoe for equestrian sport that is optimally prepared and designed for accommodating the cleats to be locked into it.

This object is achieved in that the holes on the underside of the horseshoe have a locking projection of smaller diameter with a depth of 3-5 mm corresponding to the cleats.

The horseshoes in accordance with the invention are particularly well adapted to the cleats to be locked in the horseshoe so that secure, simple and durable locking is guaranteed. They therefore have a locking projection on the underside of the horseshoe which is of smaller diameter than the remainder of the hole and which on the basis of its design and arrangement corresponds to the locking area of the cleat.

A particularly advantageous embodiment envisages that the locking projection has a depth of 4 mm. This measure should correspond to the distance between the locking elements and a stop on the cleat so that precise locking is guaranteed. However, as the locking elements themselves only secure the cleat against pulling out in the direction its longitudinal axis it is necessary to ensure additional hold for the cleat, especially also in the radial direction. In the first instance this is brought about by the cylindrical area formed by the locking projection as a result of which as precise finishing of this area as possible is necessary.

Of particular relevance in this is the relationship of the practically two-part hole and/or the two diameters with regard to the actual hole and with regard to the locking projection as its lower section to each other. To this end it is proposed that the locking projection has a diameter that is approx. 80-85% of the diameter of the hole. As a conventional horseshoe has a thickness of 10 mm this corresponds to a depth of the locking projection of 4 mm, as has already been stated.

Optimally this size relationship between the diameters is selected if the locking projection has a diameter that corresponds to 83.3% of the diameter of the hole.

This is the case for example if the diameter of the hole is approx. 12 mm and the diameter of the lock projection is approx. 9.5-10 mm, preferably 9.7 mm.

Due to the high stability requirements, particularly in respect of the lateral hold of the cleat in the hole/the locking projection, it is expedient if the locking projecting is subsequently finished with a reamer. Here the use of a 10H7 reamer is proposed with which particularly good adaptation to the external contours of the locking cleat is achieved in the relevant area between the locking elements and the stop.

Usually the holes for accommodating the locking cleats are produced in a separate working stage. This applies in particular to the old designs with screw-type connections as well as the locking cleats. For this, the use of several drills is necessary which can be dispensed with by way of a new proposal. This provides that during the production and/or finishing of the horseshoe one drilling core is positioned at the location of the subsequent hole which is designed to correspond thereto. During the production or finishing of the horseshoe this drilling core is positioned at the point at which a hole would otherwise have to be made in a separate working stage. Instead, only one drilling core is provided which after production and cooling of the forged iron is simply removed leaving behind the hole as such. The locking cleat can then be directly inserted into it. In addition, with this variant of the invention errors by the smith are prevented, in particular in relation to the incorrect diameter or incorrect positioning of the hole.

In addition, it is envisaged that the drilling core is made of hardened metal compared with the horseshoe. In this way the drilling core can be removed from the hole after production of the horseshoe with a simple blow. Fundamentally two variants of the drilling core are conceivable, namely the variant with a graded drilling core which is designed corresponding to the actual hole and in another section corresponding to the locking projection. The alternative to this envisages a drilling core of constant diameter which is designed to correspond to the diameter of the locking projection. Here it is necessary for the actual hole to be produced from the upper side of the horseshoe and taken down until the locking projection in accordance with the invention remains in the depth corresponding to the cleats.

The task in accordance with the invention is also solved by a horseshoe characterized in that in at least one of the holes an adapter is inserted which serves to accommodate the cleat.

In this case the cleat should not be positioned directly in the horseshoe, but an adapter is placed between the cleat and the horseshoe. This is in the hole either over its entire depth or in a version with a locking projection only fixed in the latter and designed so that the locking cleat is securely and reliably held there. The adapter serves to stabilise the hole in the horseshoe and at the same time constitutes a certain standardisation in that the cleats only have to be adapted to the adapter, irrespective of the quality of the horseshoe.

Preferably it is envisaged that the adapter is designed as a cylinder with a diameter corresponding to that of the locking projection. As with time, softer horseshoes, made of aluminium for example, are becoming increasingly popular, it may be necessary to use the adapters in accordance with the invention as a type of stabilisation sleeve in such materials in order to prevent the cleats eating into the softer material of the horseshoe and thereby ensuring that the grip is lost. As the locking projection is the relevant area which corresponding to the cleats is between the stop and the spring elements, it is sufficient in principle for the adapter to be comparatively short just in this part of the hole. However, it is also conceivable to design the adapter as a graded cylinder with two different diameters one of which corresponds to the actual hole and the other to the locking projection.

With regard to the connection between the horseshoe and the adapter, the principal idea is for the adapter to be connected to the horseshoe by means of a screw-type connection. For this, the adapter has an external thread that corresponds to an internal thread on the horseshoe or in the hole in the horseshoe.

It is clear that in the form of embodiment with a locking projection the principal idea for the adapter is to be connected to the locking projection by means of a screw-type connection.

A further preferred form of embodiment of the invention envisages that the adapter has a collar on the end facing the underside of the horseshoe and that the adapter therefore rests around the hole with its collar on the underside of the horseshoe. This adapter evens out any unevenness on the underside of the horseshoe and at the same time provides a gripping surface for a tool in order to insert the adapter into the hole and/or unscrew it from the hole.

In this respect it is proposed that the collar is essentially square-shaped whereby the edges can be bevelled in order to facilitate the application of a tool.

It is also envisaged that the adapter is made of a hardened material. Especially in the case of horseshoes made of a softer material, e.g. aluminium, but also in the case of comparatively harder materials, this has the advantage that in the end the hardness of the adapter determines the stability of the locking connection. In this way the aforementioned standardisation can be guaranteed relatively independently of the quality of the horseshoe as there does not have to be a direct connection between the horseshoe and the cleat. Rather, the adapter initially serves to take up the forces and moments. It is also conceivable for the adapter to be inserted into the horseshoe both before and after forging. A further advantage consists in the fact that as a result of the design and arrangement of the adapter the quality of the underside of the horseshoe is of secondary importance.

The invention is characterised in particular in that a horseshoe for equestrian sport is created which is particularly suitable for accommodating locking cleats as on the underside of the horseshoe there is a locking projection, with a diameter smaller than that of the actual hole, with is approx. 3-5 mm in depth and therefore guarantees sufficient lateral hold for the cleats. This is due on the one hand to the fact that the proposed depth is adequately dimensioned to guarantee lateral hold and bring about a locking connection between the stop and spring elements in the locking area of the cleat, and on the other hand to the fact that the area can be prepared and finished with particular precision. Between the holes in the horseshoe and the locking cleats adapters made of a hardened material can also be positioned that are screwed into the hole in the horseshoe and in which the locking cleats are in turn positioned.

Further details of the subject matter of the invention are set out in the following description of the accompanying drawing showing a preferred example of embodiment with the necessary details and component parts.

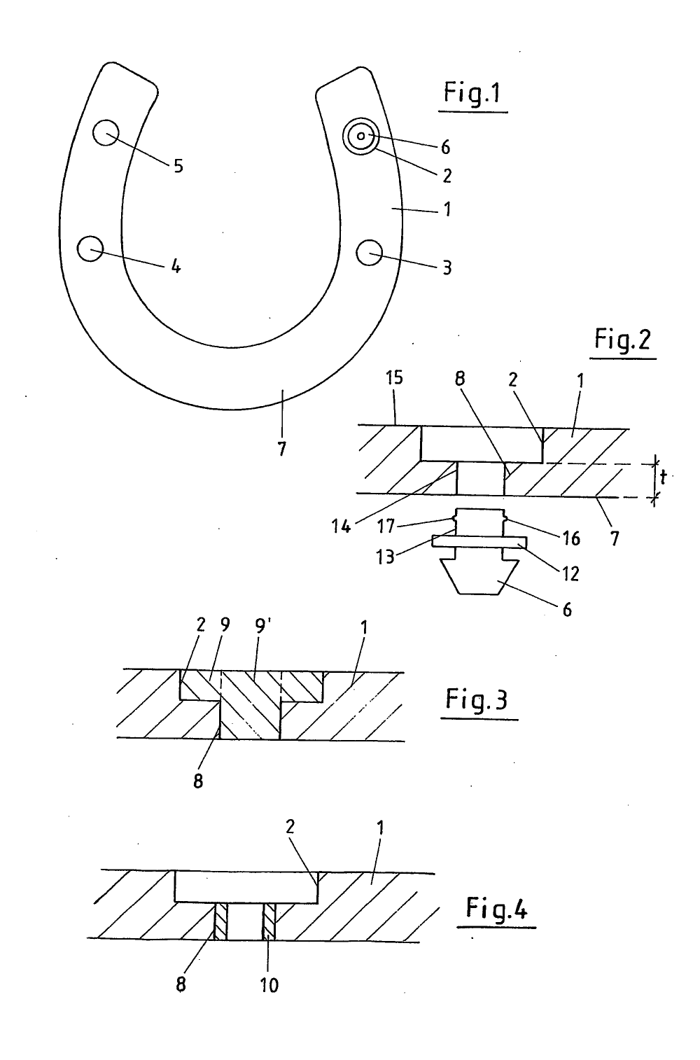

FIG. 1 shows a top view of a horseshoe

FIG. 2 shows a cleat and a hole

FIG. 3 shows a hole with a drilling core

FIG. 4 shows a hole with a stabilising sleeve

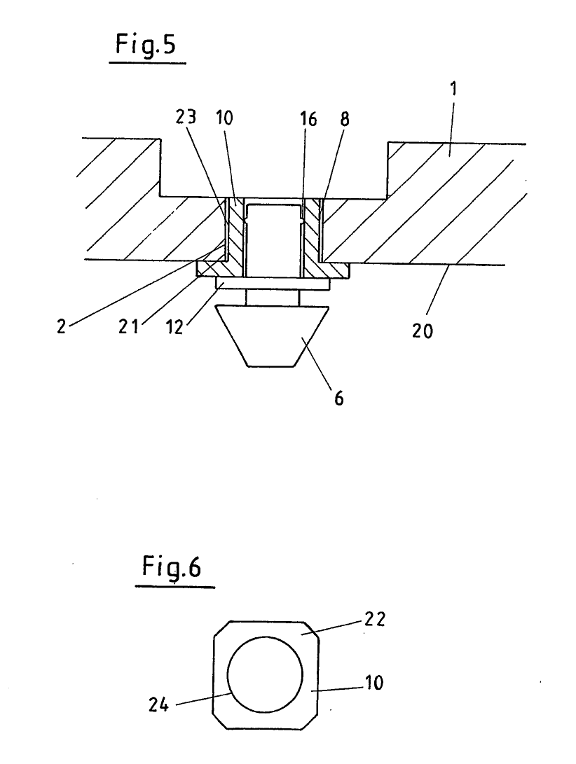

FIG. 5 shows an inserted cleat with adapter and

FIG. 6 shows a top view of an adapter.

FIG. 1 shows horseshoe 1 with holes 2, 3, 4 and 5 seen from the underside 7. A cleat 6 is inserted into the hole 2, which is in principle covered, for illustration purposes only.

FIG. 2 shows a hole, comprising the actual hole 2 and the locking projection 8 of smaller diameter. This is therefore practically a two-part hole. The depth of this locking projection 8 is dimensioned here so that adequate, mainly lateral, hold is given in addition to the locking elements for the cleat 6. Therefore the depth t corresponds with cleat 6 namely in its locking area 13 between the stop 12 on the one hand and the locking elements 16 and 17 on the other hand. In order to produce the hole 2 the hole 14 is initially driven into the horseshoe from the underside 7, after which the actual hole 2 is driven from the upper side 15 of the horseshoe so that the locking projection 8 is formed. This should be subsequently precision-finished with a reamer in order to bring about a precise connection between horseshoe 1 and the locking cleat 6 used.

FIG. 3 shows the horseshoe 1 with the hole 1 in which the drilling core 9 is inserted. This can also be made of a hardened material and can thus be removed after production and/or finishing of the horseshoe 1 by a simple blow. Shown by 9′ and in dashed form is a variant of this drilling core 9 in which its diameter only corresponds to the diameter of the locking projection 8. After removing this drilling core 9′ the actual hole 2 with the larger diameter would still have to be made.

In addition to this, FIG. 4 shows a horseshoe 1 with an adapter 10 which is also made of harder material than the horseshoe 1, the primary purpose of which is to provide lateral hold for the cleat in the area of the locking projection, in particular if the horseshoe is made of a softer material, such as aluminium for example.

FIG. 5 shows a cross-section through the horseshoe with the inserted cleat 6, here with an adapter 10. In this embodiment the adapter 10 is only positioned in the locking projection 8. The adapter 10 is essentially in the shape of a cylinder 11 and on the end 21 facing the underside 20 the adapter 10 has a collar 22. It can be clearly seen that the adapter 10 fully juts out on the underside 20 of the horseshoe 1 and projects from the hole 2. The cleat 6 is inserted into the adapter 10 with the stop and the locking elements 16. The adapter 10 itself is connected to the horseshoe 1 by way of the screw-connection 23 in the form of a thread.

Finally, FIG. 6 show a top view of the adapter 10. The quadrilateral contour of the collar 22 with the bevelled edges can be seen which provides a good grip surface for a tool. The opening 24 is for accommodating the cleat which is not shown here.

All the stated features, including those gleaned only from the drawings, are considered essential to the invention, both alone and in combination.

1. Horseshoe (1) for equestrian sport with several holes (2, 3, 4, 5) for accommodating locking cleats (6),
characterized in that,
the holes (2) on the underside (7) of the horseshoe (1) have a locking projection (8) of smaller diameter with a depth of 3-5 mm corresponding to the cleats (6).

2. Horseshoe in accordance with claim 1,
characterized in that,
the locking projection (8) has a depth of 4 mm.

3. Horseshoe in accordance with claim 1,
characterized in that
the locking projection (8) has a diameter that is approx. 80-85% of the diameter of the hole (2).

4. Horseshoe in accordance with claim 3,
characterized in that
the locking projection (8) has a diameter that is 83.3% of the diameter of the hole (2).

5. Horseshoe in accordance with claim 3,
characterized in that
the diameter of the hole (2) is approx. 12 mm and the diameter of the locking projection (8) approx. 9.5-10 mm, preferably 9.7 mm.

6. Horseshoe in accordance with claim 1,
characterized in that
the locking projection (8) is subsequently finished with a reamer.

7. Horseshoe in accordance with claim 1,
characterized in that
in the production and/or finishing of the horseshoe (1) a drilling core (9) is positioned at the point of the subsequent hole (2) and is designed corresponding thereto.

8. Horseshoe in accordance with claim 7,
characterized in that
the drilling core (9) is made of hardened metal.

9. Horseshoe (1) for equestrian sport with several holes (2, 3, 4, 5) for accommodating locking cleats (6),
characterised in that
in at least one of the holes (2) an adapter (10) is inserted which serves to accommodate a cleat (6).

10. Horseshoe in accordance with claim 9,
characterized in that
the adapter (10) is designed as a cylinder (11) the diameter of which corresponds to the locking projection (8).

11. Horseshoe in accordance with claim 9,
characterized in that
the adapter (10) is connected to the horseshoe (1) by means of a screw-type connection

12. Horseshoe in accordance with claim 9,
characterized in that
the adapter (1) is connected via a screw-type connection (23) to the locking projection (8)

13. Horseshoe in accordance with claim 9,
characterized in that
the adapter (10) has a collar (22) at its end (21) facing the underside (20) of the horseshoe (1).

14. Horseshoe in accordance with claim 13,
characterized in that
the collar (22) is essentially square-shaped.

15. Horseshoe in accordance with claim 9,
characterized in that
the adapter (10) is made of a hardened material.
